(19) United States
(12) Patent Application Publication
(10) Pub. No.: US 2026/0238321 A1
(43) Pub. Date: Aug. 13, 2026

(54) Method and Apparatus for Beam Failure Recovery and Transmission Configuration Indication (TCI) State Indication for Multiple Transmission/Reception Points (mTRP) in Wireless Communication

(71) Applicant: Apple Inc., Cupertino, CA (US)

(72) Inventors: Hong He, San Jose, CA (US); Jie Cui, San Jose, CA (US); Dawei Zhang, Saratoga, CA (US); Wei Zeng, Saratoga, CA (US); Haitong Sun, Saratoga, CA (US); Huaning Niu, San Jose, CA (US); Ankit Bhamri, Haar (DE); Chunxuan Ye, San Diego, CA (US); Chunhai Yao, Beijing (CN); Seyed Ali Akbar Fakoorian, San Diego, CA (US)

(21) Appl. No.: 19/154,970

(22) PCT Filed: Feb. 10, 2023
(86) PCT No.: PCT/CN2023/075382

§ 371 Date: Aug. 8, 2025

(51) Int. Cl. H04B 7/06; H04W 24/08; H04W 72/231; H04W 72/51; H04W 76/20; H04W 80/02

(52) U.S. Cl. CPC H04B 7/06968; H04W 24/08; H04W 72/231; H04W 72/51; H04W 76/20; H04W 80/02

(57) ABSTRACT

Methods and Apparatus for the efficiency of multi-beam, multi-Transmission Reception Point (mTRP) reception and transmission operations using a Transmission Configuration Indicator (TCI) state framework. Implicit mappings for mTRP communication in the light-weight TCI framework is used to enhance Beam Failure Detection (BFD) and Beam Failure Recovery (BFR) operations. The TCI framework is further used in decoding a Coherent Joint Transmission (CJT)-Physical Downlink Shared Channel (PDSCH) that is joint precoded and transmitted across a plurality of TRPs. The TCI framework is further used in aperiodic Channel State Information (CSI) reporting in single Downlink Control Information (sDCI) and multiple Downlink Control Information (mDCI) communication with multiple mTRPs.

### FIELD

The present application relates to wireless devices and wireless networks, including devices, circuits, and methods for Beam Failure Recovery (BFR) and Transmission Configuration Indication (TCI) State Indication for Multiple Transmission/Reception Points (mTRP) in Wireless Communication.

### BACKGROUND

Wireless communication systems are rapidly growing in usage. In recent years, wireless devices such as smart phones and tablet computers have become increasingly sophisticated. In addition to supporting telephone calls, many mobile devices now provide access to the internet, email, text messaging, and navigation using the global positioning system (GPS) and are capable of operating sophisticated applications that utilize these functionalities. Additionally, there exist numerous different wireless communication technologies and standards. Some examples of wireless communication standards include GSM, UMTS (associated with, for example, WCDMA or TD-SCDMA air interfaces), LTE, LTE Advanced (LTE-A), HSPA, 3GPP 2 CDMA 2000 (e.g., 1xRTT, 1xEV-DO, HRPD, eHRPD), IEEE 802.11 (WLAN or Wi-Fi), and BLUETOOTH™, among others.

The ever-increasing number of features and functionality introduced in wireless communication devices also creates a continuous need for improvement in both wireless communications and in wireless communication devices. To increase coverage and better serve the increasing demand and range of envisioned uses of wireless communication, in addition to the communication standards mentioned above, there are further wireless communication technologies under development, including the fifth generation (5G) standard and New Radio (NR) communication technologies. Accordingly, improvements in the field in support of such development and design are desired.

After the initial deployment of NR, the TCI state framework was unnecessarily flexible, which lead to significant signaling overhead. Later, a unified TCI framework was introduced (Release 17) that facilitates streamlined multi-beam operation in Frequency Range 2 (FR2) for a single Transmission/Reception Point (sTRP). Further extension of unified TCI framework that focuses on multi-TRP use cases would be beneficial.

More specifically, in current mTRP Beam Management (BM) designs, implicit Beam Failure Detection (BFD) is not supported for single Downlink Control Information (sDCI) mTRP. Also, although an aperiodic Channel State Indication (CSI)-Reference Signal (RS) resource can be used for CSI feedback in a sTRP TCI framework, associating the TCI state for CSI-Reference Signal (RS) resources for different TRPs has yet to be established.

### SUMMARY

In one aspect, embodiments relate to a method of BFD that includes a User Equipment (UE) receiving a first DCI format that includes a TCI field that indicates one of a plurality of active TCI states. A codepoint of the TCI state indicator field is associated with a first TCI state and a second TCI state. The first TCI state is associated with a first TRP, and the second TCI state associated with a second TRP. The method includes determining that sDCI mTRP communication is enabled and that no Beam Failure Detection-Reference Signal (BFD-RS) resource set was explicitly configured in any previous Radio Resource Control (RRC) signal received by the UE. The method further includes deriving a first BFD-RS resource set by including the RS sets indicated by the first TCI state, and deriving a second BFD-RS resource set by including the RS sets indicated by the second TCI state. BFD is performed based, at least in part, on a first radio link quality measurement obtained from the first BFD-RS resource set for the first TCI state and a second measurement obtained from the second BFD-RS resource set for the second TCI state.

In another aspect, embodiments relate to a method of BFD that includes a UE receiving a Medium Access Control-Control Element (MAC-CE) that includes a plurality of active TCI states. A pair of active TCI states of the plurality of active TCI states consists of a first TCI state and a second TCI state. The first TCI state is associated with a first TRP, and the second TCI state is associated with a second TRP. The method includes the UE transmitting a number of BFD-RS resources per set capability of the UE to the network in a UE capability message. The UE determines that sDCI mTRP communication is enabled and that no BFD-RS resource set was explicitly configured in any previous RRC signal. The method includes deriving a first BFD-RS resource set by including the RS sets of the first TCI state of an active TCI state pair of the plurality of active TCI states and deriving a second BFD-RS resource set by including the RS sets of the second TCI state of the active TCI state pair of the plurality of active TCI states. The method further includes repeatedly associating additional BFD-RS resources by including the RS sets of a first TCI state and a second TCI state of the remaining active TCI state pairs to the first BFD-RS resources set and the second BFD-RS resource sets, respectively, until the number of BFR-RS resources per set is equal to the capability reported by the UE. The additional BFD-RS resources may be associated using RSs of the plurality of active TCI state pairs based on a periodicity of the search space set and a value of a Control Resource Set (CORESET) index that is associated with the active TCI-states in the active TCI state pair.

In another aspect, embodiments are related to a method of Beam Failure Recovery (BFR) that includes a UE detecting a beam failure based on a measurement obtained from a BFD-RS resource. The UE determines a BFD-RS set identification (ID) associated with the failed BFD-RS resource and a Candidate Beam Detection (CBD)-RS ID. The BFD-RS set and CBD-RS set are associated with the same TRP with a same TCI-state. The UE transmits a MAC-CE that includes the BFD-RS set ID and the CBD-RS ID to the network. Upon receiving a response to the transmission of the MAC-CE, the UE determines an uplink spatial filter based on the CBD-RS associated with the CBD-RS ID and transmits the uplink channels using the uplink spatial filter.

In another aspect, embodiments are related to a method of decoding a Coherent Joint Transmission (CJT)-Physical Downlink Shared Channel (PDSCH), the CJT-PDSCH being joint precoded and transmitted across a plurality of Transmission Reception Points (TRPs). The method includes receiving an indication of a first and second unified joint Downlink (DL) TCI state from a network. A first CJT-PDSCH Demodulation Reference Signal (DMRS) port is quasi-co-located with a DL RS of the first unified joint DL TCI state by quasi co-location (QCL) Type A. The method includes determining a QCL Type of a second CJT-PDSCH DMRS port with respect to a second DL RS of the second unified joint DL TCI state and decoding the CJT-PDSCH using the first and second CJT-PDSCH DMRS ports. The QCL type of the second CJT-PDSCH DMRS port with respect to the second DL RS of the second unified joint DL TCI state may be Type A, B, or C, or a new Type E.

In another aspect, embodiments are related to a method of aperiodic channel state indication (CSI) reporting that includes a UE receiving an indication of a first unified joint DL TCI state and a second unified joint DL TCI state for beam management and CSI reporting. The UE receives a first indication of a first aperiodic CSI resource set to use for aperiodic CSI reporting and a second indication of a second aperiodic CSI resource set to use for aperiodic CSI reporting. The first indication includes a first bit indicator that indicates either the first unified joint DL TCI state or the second unified joint DL TCI state, and the second indication includes a second bit indicator that indicates either the first unified joint DL TCI state or the second unified joint DL TCI state. Aperiodic CSI reporting is performed by applying the unified joint DL TCI state indicated by the first bit indicator to the first aperiodic CSI resource set and applying the unified joint DL TCI state indicated by the second bit indicator to the second aperiodic CSI resource set.

In another aspect, embodiments are related to a method of aperiodic CSI reporting using sDCI mTRP communication that includes a UE receiving an indication of a first and second unified joint DL TCI state through RRC signaling. The UE performs group-based aperiodic CSI-RS reporting with at least two aperiodic CSI resource sets, with the aperiodic CSI resource sets each having an identification. The method includes associating a first TRP associated with the first unified DL TCI state with a first CSI resource set having a lower value identification and associating a second TRP associated with the second unified DL TCI state with a second CSI resource set having an identification greater than the lower value identification. The aperiodic CSI-RS reporting is performed using the first CSI resource set and the second CSI resource set.

In another aspect, embodiments are related to a method of aperiodic CSI reporting using multiple downlink control information (mDCI) mTRP communication that includes the UE receiving an indication of a first and second unified joint Downlink (DL) Transmission Configuration Indicator (TCI) state through Radio Resource Control (RRC) signaling. The UE performs group-based aperiodic CSI-RS reporting with at least two aperiodic CSI resource sets, the aperiodic CSI resource sets each having an identification. A first TRP associated with the first unified DL TCI state is associated with a first CSI resource set, the first TRP being associated with a coresetPoolIndex equal to 0 and the first CSI resource set having a lower value identification. A second TRP associated with the second unified DL TCI state is associated with a second CSI resource set, the second TRP being associated with a coresetPoolIndex equal to 1 and the second CSI resource set having an identification greater than the lower value identification. Aperiodic CSI-RS reporting is performed using at least the first CSI resource set and the second CSI resource set.

In some embodiments, each of the first unified joint DL TCI state and the second unified joint DL TCI state may not not include a bit indicator that indicates a first TRP or a second TRP associated of the unified joint DL TCI state.

The techniques described herein may be implemented in and/or used with a number of different types of devices, including but not limited to cellular phones, wireless devices, tablet computers, wearable computing devices, portable media players, Internet of Things (IOT) devices, vehicles, and any of various other computing devices.

This Summary is intended to provide a brief overview of some of the subject matter described in this document. Accordingly, it will be appreciated that the above-described features are merely examples and should not be construed to narrow the scope or spirit of the subject matter described herein in any way. Other features, aspects, and advantages of the subject matter described herein will become apparent from the following Detailed Description, Figures, and Claims.

### BRIEF DESCRIPTION OF DRAWINGS

A better understanding of the present subject matter may be obtained when the following detailed description of various aspects is considered in conjunction with the following drawings:

FIG. 1 illustrates an example wireless communication system, according to some aspects.

FIG. 2 illustrates another example of a wireless communication system, according to some aspects.

FIG. 3 illustrates an example block diagram of a UE, according to some aspects.

FIG. 4 illustrates an example block diagram of a Base Station (BS), according to some aspects.

FIG. 5 illustrates an example system, in accordance with some aspects.

FIG. 6 illustrates a flow chart for beam failure detection (BFD), according to some aspects.

FIG. 7 illustrates a reference chart, according to some aspects.

FIGS. 8A and 8B illustrate examples of establishing a BFD-RS set, according to some aspects.

FIG. 9 is a flowchart for beam failure recovery (BFR), according to some aspects.

FIGS. 10A and 10B illustrate beam failure recovery (BFR), according to some aspects.

FIG. 11 is a flowchart for Coherent Joint Transmission (CJT)-Physical Downlink Shared Channel (PDSCH) transmission, according to some aspects.

FIG. 12 is a flowchart for aperiodic CSI reporting, according to some aspects.

While the features described herein may be susceptible to various modifications and alternative forms, specific aspects thereof are shown by way of example in the drawings and are herein described in detail. It should be understood, however, that the drawings and detailed description thereto are not intended to be limiting to the particular form disclosed, but on the contrary, the intention is to cover all modifications, equivalents and alternatives falling within the spirit and scope of the subject matter as defined by the appended claims.

### DETAILED DESCRIPTION

There is a need to study enhancements to multi-beam operation in mobile services and mobile devices. The evolution of the 5G and New Radio (NR) standards need to continuously improve energy network efficiency and energy savings for user equipment (UE) devices and base station (BS) devices. Improvements are needed in terms of both transmission and reception procedures.

In one or more embodiments described herein, improvements are made to improve the efficiency of multi-beam, multi-TRP reception and transmission operations in wireless communications. The improvements are made for these communications between UE devices and BS devices.

Embodiments disclosed herein address one or more of the issues described above by providing implicit mappings for mTRP communication in a light-weight TCI framework. Embodiments include implicit BFD-RS mapping that may reduce signaling overhead.

Further, embodiments disclosed herein provide support for support of Coherent Joint Transmission (CJT) PDSCH reception. In CJT, a PDSCH is joint precoded and transmitted across up to four TRPs. Embodiments disclosed herein help define the unified TCI States for CJT-PDSCH.

The following is a glossary of additional terms that may be used in this disclosure:
Memory Medium—Any of various types of non-transitory memory devices or storage devices. The term “memory medium” is intended to include an installation medium, (e.g., a CD-ROM, floppy disks, or tape device; a computer system memory or random-access memory such as DRAM, DDR RAM, SRAM, EDO RAM, Rambus RAM), a non-volatile memory such as a Flash, magnetic media (e.g., a hard drive, or optical storage; registers, or other similar types of memory elements). The memory medium may include other types of non-transitory memory as well or combinations thereof. In addition, the memory medium may be located in a first computer system in which the programs are executed or may be located in a second different computer system which connects to the first computer system over a network, such as the Internet. In the latter instance, the second computer system may provide program instructions to the first computer for execution. The term “memory medium” may include two or more memory mediums which may reside in different locations (e.g., in different computer systems that are connected over a network). The memory medium may store program instructions (e.g., embodied as computer programs) that may be executed by one or more processors.
Carrier Medium—a memory medium as described above, as well as a physical transmission medium, such as a bus, network, and/or other physical transmission medium that conveys signals such as electrical, electromagnetic, or digital signals.
Programmable Hardware Element—includes various hardware devices comprising multiple programmable function blocks connected via a programmable interconnect. Examples include FPGAs (Field Programmable Gate Arrays), PLDs (Programmable Logic Devices), FPOAs (Field Programmable Object Arrays), and CPLDs (Complex PLDs). The programmable function blocks may range from fine grained (combinatorial logic or look up tables) to coarse grained (arithmetic logic units or processor cores). A programmable hardware element may also be referred to as “reconfigurable logic.”
User Equipment (UE) (also “User Device,” “UE Device,” or “Terminal”)—any of various types of computer systems or devices that are mobile or portable and that perform wireless communications. Examples of UE devices include mobile telephones or smart phones (e.g., iPhone™, Android™-based phones), portable gaming devices (e.g., Nintendo Switch™, Nintendo DS™, Play Station Vita™, Play Station Portable™, Gameboy Advance™, iPhone™), laptops, wearable devices (e.g., smart watch, smart glasses), PDAs, portable Internet devices, music players, data storage devices, other handheld devices, in-vehicle infotainment (IVI), in-car entertainment (ICE) devices, an instrument cluster, head-up display (HUD) devices, onboard diagnostic (OBD) devices, dashtop mobile equipment (DME), mobile data terminals (MDTs), Electronic Engine Management System (EEMS), electronic/engine control units (ECUs), electronic/engine control modules (ECMs), embedded systems, microcontrollers, control modules, engine management systems (EMS), networked or “smart” appliances, machine type communications (MTC) devices, machine-to-machine (M2M), internet of things (IoT) devices, and the like. In general, the terms “UE” or “UE device” or “terminal” or “user device” may be broadly defined to encompass any electronic, computing, and/or telecommunications device (or combination of devices) that is easily transported by a user (or vehicle) and capable of wireless communication.
Wireless Device—any of various types of computer systems or devices that perform wireless communications. A wireless device may be portable (or mobile) or may be stationary or fixed at a certain location. A UE is an example of a wireless device.
Communication Device—any of various types of computer systems or devices that perform communications, where the communications may be wired or wireless. A communication device may be portable (or mobile) or may be stationary or fixed at a certain location. A wireless device is an example of a communication device. A UE is another example of a communication device.
Base Station—The terms “base station,” “wireless base station,” or “wireless station” have the full breadth of their ordinary meaning, and at least includes a wireless communication station installed at a fixed location and used to communicate as part of a wireless telephone system or radio system. For example, if the base station is implemented in the context of LTE, it may alternately be referred to as an ‘eNodeB’ or ‘eNB’. If the base station is implemented in the context of 5G NR, it may alternately be referred to as a ‘gNodeB’ or ‘gNB’. Although certain aspects are described in the context of LTE or 5G NR, references to “eNB,” “gNB,” “nodeB,” “base station,” “NB,” and the like, may refer to one or more wireless nodes that service a cell to provide a wireless connection between user devices and a wider network generally and that the concepts discussed are not limited to any particular wireless technology. Although certain aspects are described in the context of LTE or 5G NR, references to “eNB,” “gNB,” “nodeB,” “base station,” “NB,” and the like, are not intended to limit the concepts discussed herein to any particular wireless technology and the concepts discussed may be applied in any wireless system.
Node—The term “node,” or “wireless node” as used herein, may refer to one more apparatus associated with a cell that provide a wireless connection between user devices and a wired network generally.
Processing Element (or Processor)—refers to various elements or combinations of elements that are capable of performing a function in a device, such as a user equipment or a cellular network device. Processing elements may include, for example: processors and associated memory, portions or circuits of individual processor cores, entire processor cores, individual processors, processor arrays, circuits such as an Application Specific Integrated Circuit (ASIC), programmable hardware elements such as a field programmable gate array (FPGA), as well any of various combinations of the above.
Channel—a medium used to convey information from a sender (transmitter) to a receiver. It should be noted that since characteristics of the term “channel” may differ according to different wireless protocols, the term “channel” as used herein may be considered as being used in a manner that is consistent with the standard of the type of device with reference to which the term is used. In some standards, channel widths may be variable (e.g., depending on device capability, band conditions, and the like). For example, LTE may support scalable channel bandwidths from 1.4 MHz to 20 MHz. WLAN channels may be 22 MHz wide while Bluetooth channels may be 1 Mhz wide. Other protocols and standards may include different definitions of channels. Furthermore, some standards may define and use multiple types of channels (e.g., different channels for uplink or downlink and/or different channels for different uses such as data, control information, and the like).
Band—The term “band” has the full breadth of its ordinary meaning, and at least includes a section of spectrum (e.g., radio frequency spectrum) in which channels are used or set aside for the same purpose.
Configured to—Various components may be described as “configured to” perform a task or tasks. In such contexts, “configured to” is a broad recitation generally meaning “having structure that” performs the task or tasks during operation. As such, the component may be configured to perform the task even when the component is not currently performing that task (e.g., a set of electrical conductors may be configured to electrically connect a module to another module, even when the two modules are not connected). In some contexts, “configured to” may be a broad recitation of structure generally meaning “having circuitry that” performs the task or tasks during operation. As such, the component may be configured to perform the task even when the component is not currently on. In general, the circuitry that forms the structure corresponding to “configured to” may include hardware circuits.

Various components may be described as performing a task or tasks, for convenience in the description. Such descriptions should be interpreted as including the phrase “configured to.” Reciting a component that is configured to perform one or more tasks is expressly intended not to invoke 35 U.S.C. § 112(f) interpretation for that component.

### Example Wireless Communication System

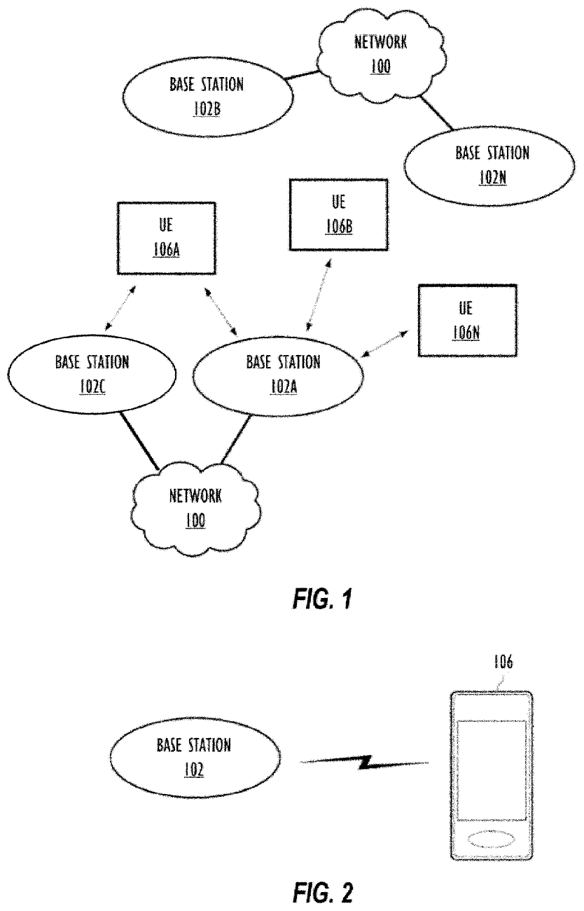

Turning now to FIG. 1, a simplified example of a wireless communication system is illustrated, according to some aspects. It is noted that the system of FIG. 1 is a non-limiting example of a possible system, and that features of this disclosure may be implemented in any of various systems, as desired.

As shown, the example wireless communication system includes a base station 102A, which communicates over a transmission medium with one or more user devices 106A and 106B, through 106N. Each of the user devices may be referred to herein as a “user equipment” (UE). Thus, the user devices 106 are referred to as UEs or UE devices.

The base station (BS) 102A may be a base transceiver station (BTS) or cell site (e.g., a “cellular base station”) and may include hardware that enables wireless communication with the UEs 106A through 106N.

The communication area (or coverage area) of the base station may be referred to as a “cell.” The base station 102A and the UEs 106 may be configured to communicate over the transmission medium using any of various radio access technologies (RATs), also referred to as wireless communication technologies, or telecommunication standards, such as GSM, UMTS (associated with, for example, WCDMA or TD-SCDMA air interfaces), LTE, LTE-A, 5G NR, HSPA, 3GPP2 CDMA2000. Note that if the base station 102A is implemented in the context of LTE, it may alternately be referred to as an ‘eNodeB’ or ‘eNB’. Note that if the base station 102A is implemented in the context of 5G NR, it may alternately be referred to as a ‘gNodeB’or ‘gNB’.

In some aspects, the UEs 106 may be IoT UEs, which may comprise a network access layer designed for low-power IoT applications utilizing short-lived UE connections. An IoT UE may utilize technologies such as M2M or MTC for exchanging data with an MTC server or device via a public land mobile network (PLMN), proximity service (ProSe) or device-to-device (D2D) communication, sensor networks, or IoT networks. The M2M or MTC exchange of data may be a machine-initiated exchange of data. An IoT network describes interconnecting IoT UEs, which may include uniquely identifiable embedded computing devices (within the Internet infrastructure), with short-lived connections. As an example, vehicles to everything (V2X) may utilize ProSe features using a side link (SL) interface for direct communications between devices. The IoT UEs may also execute background applications (e.g., keep-alive messages, status updates, and the like) to facilitate the connections of the IoT network.

As shown, the UEs 106, such as UE 106A and UE 106B, may directly exchange communication data via an SL interface 108. The SL interface 108 may be a PC5 interface comprising one or more physical channels, including but not limited to a Physical Sidelink Shared Channel (PSSCH), a Physical Sidelink Control Channel (PSCCH), a Physical Sidelink Broadcast Channel (PSBCH), and a Physical Sidelink Feedback Channel (PSFCH).

In V2X scenarios, one or more of the base stations 102 may be or act as Road Side Units (RSUs). The term RSU may refer to any transportation infrastructure entity used for V2X communications. An RSU may be implemented in or by a suitable wireless node or a stationary (or relatively stationary) UE, where an RSU implemented in or by a UE may be referred to as a “UE-type RSU,” an RSU implemented in or by an eNB may be referred to as an “eNB-type RSU,” an RSU implemented in or by a gNB may be referred to as a “gNB-type RSU,” and the like. In one example, an RSU is a computing device coupled with radio frequency circuitry located on a roadside that provides connectivity support to passing vehicle UEs (VUEs). The RSU may also include internal data storage circuitry to store intersection map geometry, traffic statistics, media, as well as applications/software to sense and control ongoing vehicular and pedestrian traffic. The RSU may operate on the 5.9 GHZ Intelligent Transport Systems (ITS) band to provide very low latency communications required for high-speed events, such as crash avoidance, traffic warnings, and the like. Additionally, or alternatively, the RSU may operate on the cellular V2X band to provide the aforementioned low latency communications, as well as other cellular communications services. Additionally, or alternatively, the RSU may operate as a Wi-Fi hotspot (2.4 GHz band) and/or provide connectivity to one or more cellular networks to provide uplink and downlink communications. The computing device(s) and some or all of the radio frequency circuitry of the RSU may be packaged in a weather enclosure suitable for outdoor installation, and it may include a network interface controller to provide a wired connection (e.g., Ethernet) to a traffic signal controller and/or a backhaul network.

As shown, the base station 102A may also be equipped to communicate with a network 100 (e.g., a core network of a cellular service provider, a telecommunication network such as a public switched telephone network (PSTN), and/or the Internet, among various possibilities). Thus, the base station 102A may facilitate communication between the user devices and/or between the user devices and the network 100. In particular, the cellular base station 102A may provide UEs 106 with various telecommunication capabilities, such as voice, SMS and/or data services.

Base station 102A and other similar base stations (such as base stations 102B through 102N) operating according to the same or a different cellular communication standard may thus be provided as a network of cells, which may provide continuous or nearly continuous overlapping service to UEs 106A-106N and similar devices over a geographic area via one or more cellular communication standards.

Thus, while base station 102A may act as a “serving cell” for UEs 106A-106N as illustrated in FIG. 1, each UE 106 may also be capable of receiving signals from (and possibly within communication range of) one or more other cells (which may be provided by base stations 102B-102N and/or any other base stations), which may be referred to as “neighboring cells.” Such cells may also be capable of facilitating communication between user devices and/or between user devices and the network 100. Such cells may include “macro” cells, “micro” cells, “pico” cells, and/or cells which provide any of various other granularities of service area size. For example, base stations 102A and 102B illustrated in FIG. 1 may be macro cells, while base station 102N may be a micro cell. Other configurations are also possible.

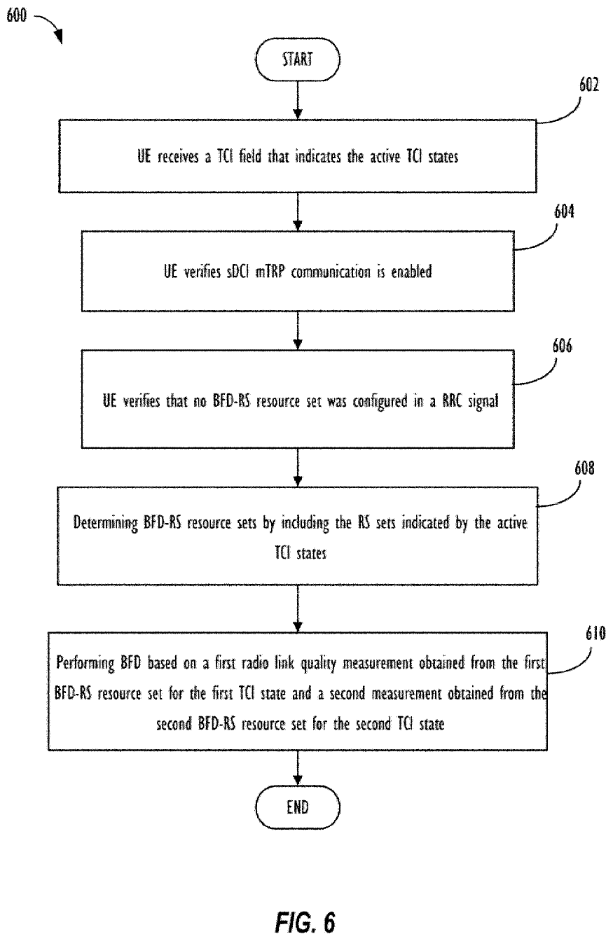

In some aspects, base station 102A may be a next generation base station, (e.g., a 5G New Radio (5G NR) base station, or “gNB”). In some aspects, a gNB may be connected to a legacy evolved packet core (EPC) network and/or to a NR core (NRC)/5G core (5GC) network. In addition, a gNB cell may include one or more TRPs. In addition, a UE capable of operating according to 5G NR may be connected to one or more TRPs within one or more gNBs. For example, it may be possible that that the base station 102A and one or more other base stations 102 support joint transmission, such that UE 106 may be able to receive transmissions from multiple base stations (and/or multiple TRPs provided by the same base station). For example, as illustrated in FIG. 1, both base station 102A and base station 102C are shown as serving UE 106A. This is further illustrated in FIG. 5.

Note that a UE 106 may be capable of communicating using multiple wireless communication standards. For example, the UE 106 may be configured to communicate using a wireless networking (e.g., Wi-Fi) and/or peer-to-peer wireless communication protocol (e.g., Bluetooth, Wi-Fi peer-to-peer, and the like) in addition to at least one of the cellular communication protocol discussed in the definitions above. The UE 106 may also or alternatively be configured to communicate using one or more global navigational satellite systems (GNSS) (e.g., GPS or GLONASS), one or more mobile television broadcasting standards (e.g., ATSC-M/H), and/or any other wireless communication protocol, if desired. Other combinations of wireless communication standards (including more than two wireless communication standards) are also possible.

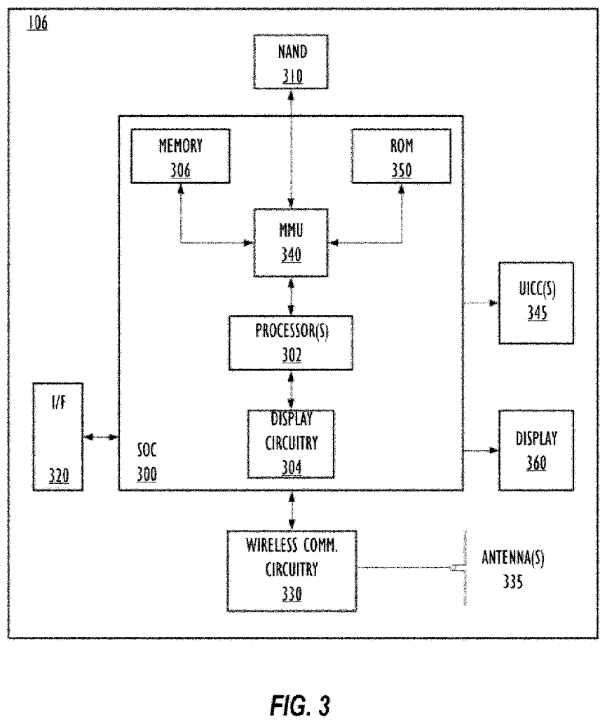

As illustrated in FIG. 2, in one or more embodiments, the UE 106 may be a device with cellular communication capability such as a mobile phone, a hand-held device, a computer, a laptop, a tablet, a smart watch, or other wearable device, or virtually any type of wireless device. Embodiments may also include vehicles, industrial equipment, or other devices that may benefit from multi-panel wireless connectivity.

The UE 106 may include a processor (processing element) that is configured to execute program instructions stored in memory. The UE 106 may perform any of the method aspects described herein by executing such stored instructions. Alternatively, or in addition, the UE 106 may include a programmable hardware element such as an FPGA (field-programmable gate array), an integrated circuit, and/or any of various other possible hardware components that are configured to perform (e.g., individually or in combination) any of the method aspects described herein, or any portion of any of the method aspects described herein.

The UE 106 may include one or more antennas for communicating using one or more wireless communication protocols or technologies. In some aspects, the UE 106 may be configured to communicate using, for example, NR or LTE using at least some shared radio components. As additional possibilities, the UE 106 could be configured to communicate using CDMA2000 (1×RTT/1xEV-DO/HRPD/eHRPD) or LTE using a single shared radio and/or GSM or LTE using the single shared radio. The shared radio may couple to a single antenna, or may couple to multiple antennas (e.g., for a multiple-input multiple output (MIMO) configuration) for performing wireless communications. In general, a radio may include any combination of a baseband processor, analog RF signal processing circuitry (e.g., including filters, mixers, oscillators, amplifiers, and the like), or digital processing circuitry (e.g., for digital modulation as well as other digital processing). Similarly, the radio may implement one or more receive and transmit chains using the aforementioned hardware. For example, the UE 106 may share one or more parts of a receive and/or transmit chain between multiple wireless communication technologies, such as those discussed above.

In some aspects, the UE 106 may include separate transmit and/or receive chains (e.g., including separate antennas and other radio components) for each wireless communication protocol with which it is configured to communicate. As a further possibility, the UE 106 may include one or more radios which are shared between multiple wireless communication protocols, and one or more radios which are used exclusively by a single wireless communication protocol. For example, the UE 106 might include a shared radio for communicating using either of LTE or 5G NR (or either of LTE or 1×RTT, or either of LTE or GSM, among various possibilities), and separate radios for communicating using each of Wi-Fi and Bluetooth. Other configurations are also possible.

In some aspects, a downlink resource grid may be used for downlink transmissions from any of the base stations 102 to the UEs 106, while uplink transmissions may utilize similar techniques. The grid may be a time-frequency grid, called a resource grid or time-frequency resource grid, which is the physical resource in the downlink in each slot. Such a time-frequency plane representation is a common practice for Orthogonal Frequency Division Multiplexing (OFDM) systems, which makes it intuitive for radio resource selection. Each column and each row of the resource grid corresponds to one OFDM symbol and one OFDM subcarrier, respectively. The duration of the resource grid in the time domain corresponds to one slot in a radio frame. The smallest time-frequency unit in a resource grid is denoted as a resource element. Each resource grid may comprise a number of resource blocks, which describe the mapping of certain physical channels to resource elements. Each resource block comprises a collection of resource elements. There are several different physical downlink channels that are conveyed using such resource blocks.

The physical downlink shared channel (PDSCH) may carry user data and higher layer signaling to the UEs 106. The physical downlink control channel (PDCCH) may carry information about the transport format and resource allocations related to the PDSCH channel, among other things. It may also inform the UEs 106 about the transport format, resource allocation, and HARQ (Hybrid Automatic Repeat Request) information related to the uplink shared channel. Typically, downlink scheduling (assigning control and shared channel resource blocks to the UE 102 within a cell) may be performed at any of the base stations 102 based on channel quality information fed back from any of the UEs 106. The downlink resource assignment information may be sent on the PDCCH used for (e.g., assigned to) each of the UEs.

The PDCCH may use control channel elements (CCEs) to convey the control information. Before being mapped to resource elements, the PDCCH complex-valued symbols may first be organized into quadruplets, which may then be permuted using a sub-block interleaver for rate matching. Each PDCCH may be transmitted using one or more of these CCEs, where each CCE may correspond to nine sets of four physical resource elements known as resource element groups (REGs). Four Quadrature Phase Shift Keying (QPSK) symbols may be mapped to each REG. The PDCCH may be transmitted using one or more CCEs, depending on the size of the Downlink Control Information (DCI) and the channel condition. There may be four or more different PDCCH formats defined in LTE with different numbers of CCEs (e.g., aggregation level, L=1, 2, 4, or 8).

### Example Communication Device

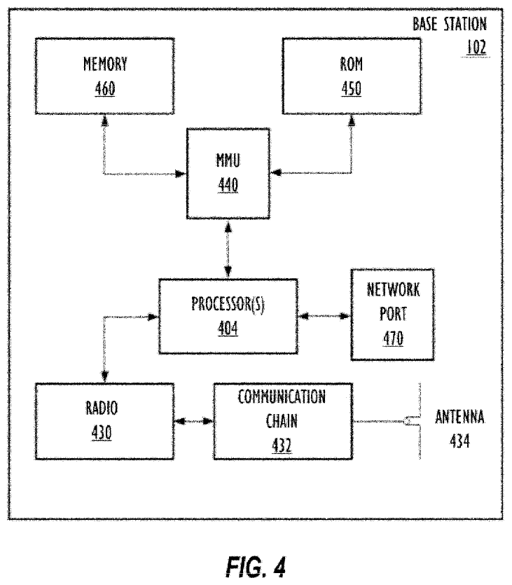

FIG. 3 illustrates an example simplified block diagram of a communication device 106, according to some aspects. It is noted that the block diagram of the communication device of FIG. 3 is only one example of a possible communication device. According to aspects, communication device 106 may be a UE device or terminal, a mobile device or mobile station, a wireless device or wireless station, a desktop computer or computing device, a mobile computing device (e.g., a laptop, notebook, or portable computing device), a tablet, and/or a combination of devices, among other devices. As shown, the communication device 106 may include a set of components configured to perform core functions. For example, this set of components may be implemented as a system on chip (SOC), which may include portions for various purposes. Alternatively, this set of components may be implemented as separate components or groups of components for the various purposes. The set of components may be coupled (e.g., communicatively; directly or indirectly) to various other circuits of the communication device 106.

For example, the communication device 106 may include various types of memory (e.g., including NAND flash 310), an input/output interface such as connector I/F 320 (e.g., for connecting to a computer system; dock; charging station; input devices, such as a microphone, camera, keyboard; output devices, such as speakers; and the like), the display 360, which may be integrated with or external to the communication device 106, and wireless communication circuitry 330 (e.g., for LTE, LTE-A, NR, UMTS, GSM, CDMA2000, Bluetooth, Wi-Fi, NFC, GPS, and the like). In some aspects, communication device 106 may include wired communication circuitry (not shown), such as a network interface card (e.g., for Ethernet connection).

The wireless communication circuitry 330 may couple (e.g., communicatively; directly or indirectly) to one or more antennas, such as antenna(s) 335 as shown. The wireless communication circuitry 330 may include cellular communication circuitry and/or short to medium range wireless communication circuitry, and may include multiple receive chains and/or multiple transmit chains for receiving and/or transmitting multiple spatial streams, such as in a MIMO configuration.

In some aspects, as further described below, cellular communication circuitry 330 may include one or more receive chains (including and/or coupled to (e.g., communicatively; directly or indirectly) dedicated processors and/or radios) for multiple Radio Access Technologies (RATs) (e.g., a first receive chain for LTE and a second receive chain for 5G NR). In addition, in some aspects, cellular communication circuitry 330 may include a single transmit chain that may be switched between radios dedicated to specific RATs. For example, a first radio may be dedicated to a first RAT (e.g., LTE) and may be in communication with a dedicated receive chain and a transmit chain shared with a second radio. The second radio may be dedicated to a second RAT (e.g., 5G NR) and may be in communication with a dedicated receive chain and the shared transmit chain. In some aspects, the second RAT may operate at mmWave frequencies. As mmWave systems operate in higher frequencies than typically found in LTE systems, signals in the mmWave frequency range are heavily attenuated by environmental factors. To help address this attenuating, mmWave systems often utilize beamforming and include more antennas as compared LTE systems. These antennas may be organized into antenna arrays or panels made up of individual antenna elements. These antenna arrays may be coupled to the radio chains.

The communication device 106 may also include and/or be configured for use with one or more user interface elements.

The communication device 106 may further include one or more smart cards 345 that include Subscriber Identity Module (SIM) functionality, such as one or more Universal Integrated Circuit Card(s) (UICC(s)) cards 345.

As shown, the SOC may include processor(s) 302, which may execute program instructions for the communication device 106 and display circuitry 304, which may perform graphics processing and provide display signals to the display 360. The processor(s) 302 may also be coupled to memory management unit (MMU) 340, which may be configured to receive addresses from the processor(s) 302 and translate those addresses to locations in memory (e.g., memory 306, read only memory (ROM) 350, NAND flash memory 310) and/or to other circuits or devices, such as the display circuitry 304, wireless communication circuitry 330, connector I/F 320, and/or display 360. The MMU 340 may be configured to perform memory protection and page table translation or set up. In some aspects, the MMU 340 may be included as a portion of the processor(s) 302.

As noted above, the communication device 106 may be configured to communicate using wireless and/or wired communication circuitry. As described herein, the communication device 106 may include hardware and software components for implementing any of the various features and techniques described herein. The processor 302 of the communication device 106 may be configured to implement part or all of the features described herein (e.g., by executing program instructions stored on a memory medium). Alternatively (or in addition), processor 302 may be configured as a programmable hardware element, such as a Field Programmable Gate Array (FPGA), or as an Application Specific Integrated Circuit (ASIC). Alternatively (or in addition) the processor 302 of the communication device 106, in conjunction with one or more of the other components 304, 306, 310, 320, 330, 340, 345, 350, 360 may be configured to implement part or all of the features described herein.

In addition, as described herein, processor 302 may include one or more processing elements. Thus, processor 302 may include one or more integrated circuits (ICs) that are configured to perform the functions of processor 302. In addition, each integrated circuit may include circuitry (e.g., first circuitry, second circuitry, and the like) configured to perform the functions of processor(s) 302.

Further, as described herein, wireless communication circuitry 330 may include one or more processing elements. In other words, one or more processing elements may be included in wireless communication circuitry 330. Thus, wireless communication circuitry 330 may include one or more integrated circuits (ICs) that are configured to perform the functions of wireless communication circuitry 330. In addition, each integrated circuit may include circuitry (e.g., first circuitry, second circuitry, and the like) configured to perform the functions of wireless communication circuitry 330.

### Example Base Station

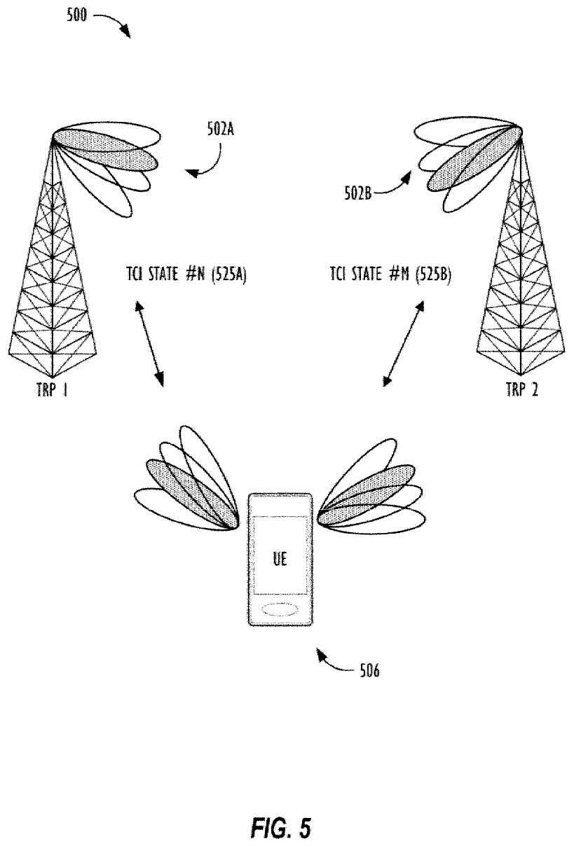

FIG. 4 illustrates an example block diagram of a base station 102, according to some aspects. It is noted that the base station of FIG. 4 is a non-limiting example of a possible base station. As shown, the base station 102 may include processor(s) 404 which may execute program instructions for the base station 102. The processor(s) 404 may also be coupled to memory management unit (MMU) 440, which may be configured to receive addresses from the processor(s) 404 and translate those addresses to locations in memory (e.g., memory 460 and read only memory (ROM) 450) or to other circuits or devices.

The base station 102 may include at least one network port 470. The network port 470 may be configured to couple to a telephone network and provide a plurality of devices, such as UE devices 106, access to the telephone network as described above in FIG. 1.

The network port 470 (or an additional network port) may also or alternatively be configured to couple to a cellular network, e.g., a core network of a cellular service provider. The core network may provide mobility related services and/or other services to a plurality of devices, such as UE devices 106. In some cases, the network port 470 may couple to a telephone network via the core network, and/or the core network may provide a telephone network (e.g., among other UE devices serviced by the cellular service provider).

In some aspects, base station 102 may be a next generation base station, (e.g., a 5G New Radio (5G NR) base station, or “gNB”). In such aspects, base station 102 may be connected to a legacy evolved packet core (EPC) network and/or to a NR core (NRC)/5G core (5GC) network. In addition, base station 102 may be considered a 5G NR cell and may include one or more transition and reception points (TRPs). In addition, a UE capable of operating according to 5G NR may be connected to one or more TRPs within one or more gNBs.

The base station 102 may include at least one antenna 434, and possibly multiple antennas. The at least one antenna 434 may be configured to operate as a wireless transceiver and may be further configured to communicate with UE devices 106 via radio 430. The antenna 434 communicates with the radio 430 via communication chain 432. Communication chain 432 may be a receive chain, a transmit chain or both. The radio 430 may be configured to communicate via various wireless communication standards, including 5G NR, LTE, LTE-A, GSM, UMTS, CDMA2000, Wi-Fi, and the like.

The base station 102 may be configured to communicate wirelessly using multiple wireless communication standards. In some instances, the base station 102 may include multiple radios, which may enable the base station 102 to communicate according to multiple wireless communication technologies. For example, as one possibility, the base station 102 may include an LTE radio for performing communication according to LTE as well as a 5G NR radio for performing communication according to 5G NR. In such a case, the base station 102 may be capable of operating as both an LTE base station and a 5G NR base station. When the base station 102 supports mmWave, the 5G NR radio may be coupled to one or more mmWave antenna arrays or panels. As another possibility, the base station 102 may include a multi-mode radio, which is capable of performing communications according to any of multiple wireless communication technologies (e.g., 5G NR and LTE, 5G NR and Wi-Fi, LTE and Wi-Fi, LTE and UMTS, LTE and CDMA 2000, UMTS and GSM, and the like).

Further, the BS 102 may include hardware and software components for implementing or supporting implementation of features described herein. The processor 404 of the base station 102 may be configured to implement or support implementation of part or all of the methods described herein (e.g., by executing program instructions stored on a memory medium). Alternatively, the processor 404 may be configured as a programmable hardware element, such as a Field Programmable Gate Array (FPGA), or as an Application Specific Integrated Circuit (ASIC), or a combination thereof. Alternatively (or in addition) the processor 404 of the BS 102, in conjunction with one or more of the other components 430, 432, 434, 440, 450, 460, 470 may be configured to implement or support implementation of part or all of the features described herein.

In addition, as described herein, processor(s) 404 may include one or more processing elements. Thus, processor(s) 404 may include one or more integrated circuits (ICs) that are configured to perform the functions of processor(s) 404. In addition, each integrated circuit may include circuitry (e.g., first circuitry, second circuitry, and the like) configured to perform the functions of processor(s) 404.

Further, as described herein, radio 430 may include one or more processing elements. Thus, radio 430 may include one or more integrated circuits (ICs) that are configured to perform the functions of radio 430. In addition, each integrated circuit may include circuitry (e.g., first circuitry, second circuitry, and the like) configured to perform the functions of radio 430.

FIG. 5 illustrates an example simplified system, according to some aspects. The system 500 illustrates mTRP communication between TRP 1 502A and a UE 506 and TRP 2 502B and the UE 506. The UE 506 is illustrated with a panel on each side, each panel with one or more transceivers capable of BM in accordance with current beamforming and MIMO techniques. In accordance with such techniques and embodiments herein, TRP 1 502A may communicate with the UE 506 via TCI State #N 525A, and TRP 2 502B may communicate with the UE 506 via TCI State #M 525B. In this context, the labels ‘M’ and ‘N’ refer to integer values used to identify a specific TCI state. Such TCI States may be associated with a lobe in the BM organization. For example, the shaded lobe in FIG. 5 may be associated with a TCI state and TRP in accordance with embodiments disclosed herein.

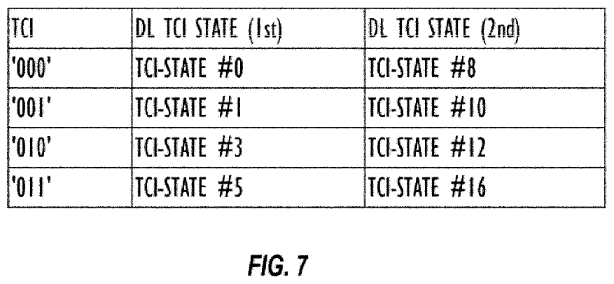

FIG. 6 shows a flow chart, in accordance with one or more embodiments disclosed herein. Embodiments of the method 600 of FIG. 6 are directed to implicit definitions of the TCI states for BFD. In block 602 of the method 600, the UE receives an indication of the active TCI states. In some embodiments, the UE may determine the TCI state associated with each control resource set (CORESET) based on a value of an indicator IE in the CORESET configuration, e.g., as received through RRC signaling. For example, one value for a given CORESET may be selected from four candidates, such as “the first”, “the second,” “Both,” or “None.”

In some embodiments, the DL TCI-state pairs may be activated by MAC-CE. The MAC-CE may be received in a PDSCH that is scheduled by a DCI detected in a Control Resource Set (CORESET).

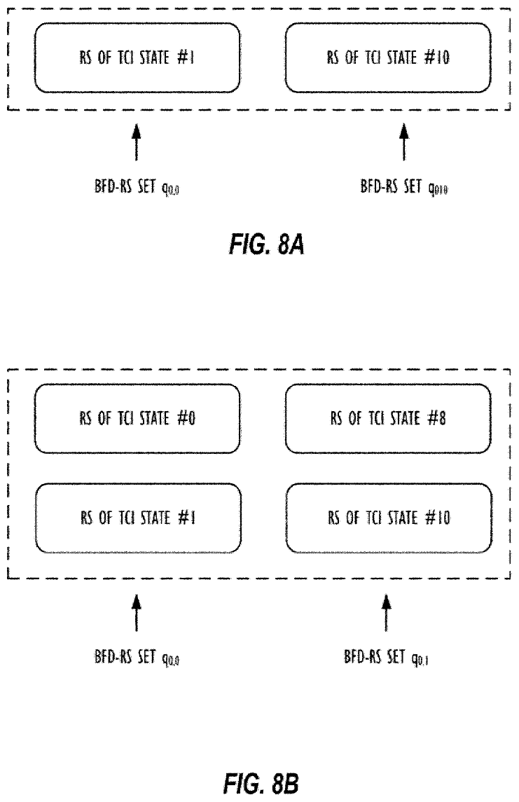

In some embodiments, TCI codepoints may be defined for TCI state pairs. An example of such an association is shown in FIG. 7. The DL TCI-state pairs may be indicated using the associated codepoints, e.g., as shown in the left-most column of the table in FIG. 7. In the example of the table shown in FIG. 7, four DL TCI-state pairs are activated by MAC-CE for the given UE. The four DL TCI-state pairs are associated with TCI codepoints ‘000’, ‘001’, ‘010’ and ‘011.’ In some embodiments, the DCI format includes a TCI field that indicates the one or more active TCI states.

As shown in FIG. 7, each codepoint of the TCI state indicator field is associated with a first TCI state and a second TCI state. The first TCI state may be associated with a first TRP, and the second TCI state may be associated with a second TRP, in accordance with some embodiments disclosed herein.

In some embodiments, the TCI state indicator further indicates a ranking of the active TCI states. For example, the lower value of the TCI state indicator indicates a smaller periodicity of the search space set. As such, lower values of the TCI state indicator may be prioritized. In some embodiments, the TCI state indicator may be assigned based on the periodicity of Search Space (SS) set (smaller periodicity to larger periodicity) and then based on the CORESET index (higher CORESET index to lower CORESET index).

Returning to FIG. 6, the UE verifies that sDCI mTRP communication is enabled in the UE in block 604. In block 606, it is verified that the UE has not been provided with TRP-specific BFD-RS resources. Such instructions may have been received through dedicated RRC signaling.

In block 608, the BFD-RS resource sets are implicitly assigned based on the indicated active TCI states. In some embodiments, the RS sets indicated by the first TCI state are implicitly assigned to the first BFD-RS resource set. Similarly, the second BFD-RS resource set is established by including the RS sets indicated by the second TCI state.

For example, UE may determine the BFD-RS set (also referred to herein as q_{0,0} and q_{0,1}) based on the indicated TCI-states for the CORESETs configured with the indicator value of the “first” and “second,” respectively. That is, the DL RS of the indicated TCI-state for the CORESETs configured with the “first” and “second” indicator value is implicitly associated with q_{0,0} and q_{0,1} of the BFD-RS set, respectively.

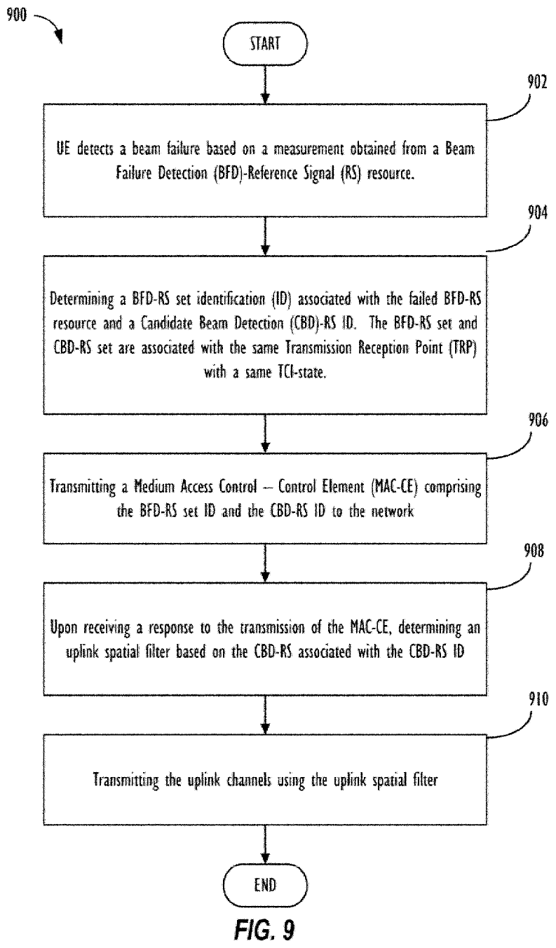

Another example of implicitly assigning BFD-RS resource sets is illustrated in FIG. 8A. In these examples, an indicated state is implicitly assigned to the BFD-RS set. For example, if the codepoint ‘001’ shown in FIG. 7 is indicated via DCI, the RS of TCI State #1 is implicitly assigned to BFD-RS set q_{0,0}, while the RS of TCI state #10 is assigned to BFD-RS q_{0,1}. Thus, the BFD-RS set is determined based on an indicated TCI-state codepoint in accordance with one or more embodiments disclosed herein.

In some embodiments, the UE may notify the network of the number of BFR-RS resources per set can be supported. Such notification may be made in a UE capability report. In such embodiments, the UE may determine the BFD-RS sets based on the activated TCI-states for CORESETs by the MAC-CE.

An example of such embodiments is illustrated in FIG. 8B. More specifically, the UE may indicate supporting up to two BFR-RS resources per set in a UE capability message. Embodiments disclosed herein are not limited to two BFR-RS resources per set. Rather, two BFR-RS resources per set is presented for demonstration purposes.

In such embodiments, based on the active states received (see, e.g., FIG. 7), the UE determines that the BFD-RS set includes DL RS resources of ‘TCI State #1’ and ‘TCI State #0’ forming the BFD-RS set q_{0,0}. Accordingly, the UE determines that the BFD-RS set includes DL RS resources of ‘TCI State #10’ and ‘TCI State #8’ forming the BFD-RS set q_{0,1}. Recall, the codepoints demonstrated in FIG. 7 may include a ranking based on periodicity of the search space sets. The UE may determine the resources for BFD-RS set using this ranking of the active states to establish the resource sets up to the number of resource sets that can be supported by the UE.

Returning to FIG. 6, in block 610, BFD is then performed based on a radio link quality measurement obtained from the BFD-RS resource set for the first TCI state(s) and a second measurement obtained from the second BFD-RS resource set for the second TCI state(s).

In accordance with one or more embodiments disclosed herein, for BFR, the UE with sDCI mTRP may be explicitly configured for candidate beam detection (CBD). That is, the UE may be explicitly configured with two sets of periodic CSI-RS or SSB index (denoted as q_{1,0} and q_{1,1}) by RRC signaling for CBD in the case of TRP-specific BFR. In some embodiments, the q_{1,0} may be implicitly associated with BFD-RS RS set q_{0,0} and linked with a TRP index #0. Further, the q_{1,1} may be implicitly associated with BFD-RS RS set q_{0,1} for a TRP index #1.

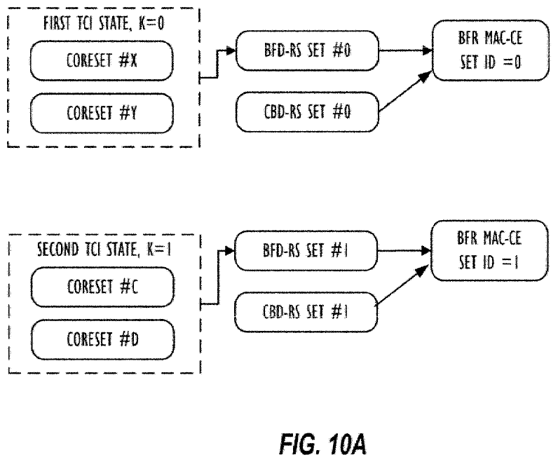

FIG. 9 shows a flow chart for BFR in accordance with one or more embodiments disclosed herein. In block 902 of the method 900, the UE detects a beam failure based on a measurement obtained from a BFD-RS resource. For example, the UE may detect a beam failure based on the measurements in embodiments described above with respect to FIG. 6.

In block 904, a BFD-RS set identification (ID) associated with the failed BFD-RS resource and a CBD-RS ID is determined. The BFD-RS set and CBD-RS set are associated with the same Transmission Reception Point (TRP) with a same TCI-state.

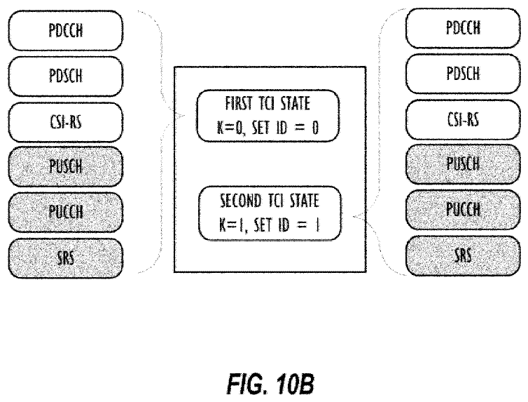

FIG. 10A provides an example of BFD-RS set implicit mapping and RRC configuration of the associated CBD-RS Set for for sDCI mTPR BFD and BFR procedure in accordance with some aspects. Referring to FIG. 10A, the ‘Set ID=0’ is associated with BFD-RS set ‘0’ and the TCI state value of ‘k=0’. Similarly, the ‘Set ID=1’ associate with BFD-RS set ‘1’ and TCI state with ‘k=1’.

Once the BFD is detected based on a given BFR-RS set, the associated BFR-RS Set ID and the identified new DL beam are included in the BFR MAC-CE and reported to network in block 906. Upon receiving a response to the transmission of the MAC-CE, an uplink spatial filter based on the CBD-RS associated with the CBD-RS ID is determined in step 908.

FIG. 10B illustrates the DL/UL Channel Beam information update after receiving the BFR response associated with a BFR MAC-CE with different ‘set ID’ and associated ‘k’ values. For example, assuming Set ID=0 is reported in BFR MAC-CE (see top of FIG. 10A), the CORESETs and PDSCH/CSI-RS associated with ‘k=0’ are updated to the new candidate beam (NCB) reported in the BFR MAC-CE, as shown on the left side of FIG. 10B. Referring to the right side of FIG. 10B, for the uplink, the UE determines uplink spatial filter based on the new candidate beam (NCB) associated with ‘k=0’ for PUSCH/PUCCH/SRS transmission. In block 910, the uplink channels are transmitted using the uplink spatial filter.

In accordance with one or more embodiments disclosed herein, for the CORESETs, after a number of symbols X from receiving the BFR response, the QCL assumption of all CORESETs may be updated. That is, the QCL assumption that all CORESETS with a value of k, (k=0 corresponding to CORESETs with TCI-State value of ‘the first’ and k=1 corresponding to CORESETs with TCI State value of ‘the second’) may be updated by the RS resource associated with the latest reported new candidate beam (if found) associated with the failed BFD-RS set q_{0,k} (k=0,1) that is reported in the BFR MAC CE.

For example, a number of symbols, say, X=28, may correspond to the smallest subcarrier spacing (SCS) of the active DL BWP for the response reception component carrier (CC) and of the active DL BWP of the CC with the failed TRP link(s) reported in the BFR MAC CE. Thus, after 28 symbols, the QCL assumption of all CORESETs associated with the k value may be updated.

In some embodiments, the UE may assume that the same QCL assumption update is applied for all PDSCH/CSI-RS that are configured by RRC signaling that share the indicated TCI-state ‘k’ value corresponding to the BFD-RS set q_{0,k} (k=0, 1) that is reported in the BFR MAC-CE.

In accordance with embodiments disclosed herein, after the UE receives the BFR response from the network associated with a number of symbols X, the UE uses the same UL spatial filter as the one associated with the index q_{new} for all PUSCH transmissions and all of PUCCH resources in a CC that are configured with the indicated TCI-state ‘k’ value. Alternatively, the UE may use the last PRACH transmission associated with the BFD-RS Set q_{0,k} (k=0, 1) for all PUSCH transmissions and all of PUCCH resources in a CC that are configured with the indicated TCI-state ‘k’ value. Such adaptations are applicable to other signals/channels configured to sharing the same TCI state as the PUSCH and all of PUCCH resources in accordance with embodiments disclosed herein.

The TCI state-based BM disclosed herein may further enhance Coherent Joint Transmission (CJT) of the PDSCH transmission. In CJT, a PDSCH may be joint precoded and transmitted across up to four TRPs. According to certain aspects of this disclosure, a UE is configured with up to unified Joint/DL TCI States to decode CJT-PDSCH.

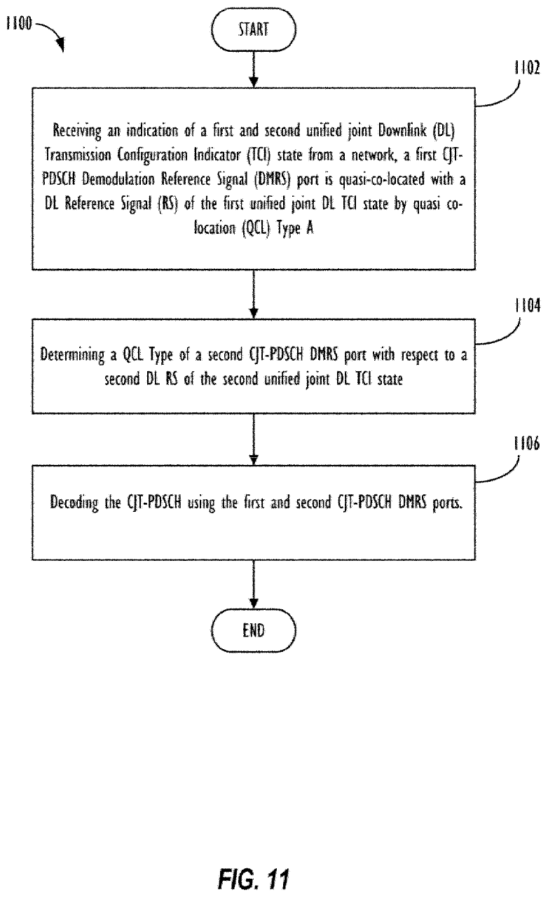

FIG. 11 shows a flowchart for CJT-PDSCH transmission according to some aspects. In the method 1100, an indication is received of a first and second unified joint DL TCI state from a network in block 1102. A first CJT-PDSCH Demodulation Reference Signal (DMRS) port is quasi-co-located with a DL RS of the first unified joint DL TCI state by the defined QCL ‘Type A’ (i.e., {Doppler shift, Doppler spread, average delay, delay spread} ).

In block 1104, a QCL Type of a second CJT-PDSCH DMRS port with respect to a second DL RS of the second unified joint DL TCI state is determined. In some embodiments, the QCL type of the second CJT-PDSCH DMRS port with respect to the second DL RS of the second unified joint DL TCI state is signaled through RRC signaling. For example, one RRC parameter, such as part of the ‘PDSCH-Config’ IE, may be used to indicate which QCL Type among the three alternatives is applied for the second indicated TCI-State.

In some embodiments, the QCL type of the second CJT-PDSCH DMRS port with respect to the second DL RS of the second unified joint DL TCI state may be Type B {Doppler shift, Doppler spread} or Type A {Doppler shift, Doppler spread, average delay, delay spread}. For Type B, delay pre-compensation is applied at network for CJT-PDSCH from the TRPs associated with the the DL RS of the ‘second’ TCI state.

In some embodiments, a new ‘Type E’ {average delay, delay spread} is defined. In such embodiments, Type E indicates a quasi co-location relationship between the second DL RS and the CJT-PDSCH DMRS port. The newly-defined Type E facilitates the Doppler shift pre-compensation applied for CJT-PDSCH from the TRPs associated with the DL RS of the ‘second’TCI state.

In block 1106, the CJT-PDSCH is decoded using the first and second CJT-PDSCH DMRS ports in accordance with embodiments disclosed herein.

According to embodiments disclosed herein, a variety of approaches may be considered to select a unified TCI State from two indicated joint/DL TCI states for aperiodic CSI resource sets that are used for Beam Management and CSI feedback. That is, the TCI-based BM techniques disclosed herein may also be applicable to aperiodic CSI reporting.

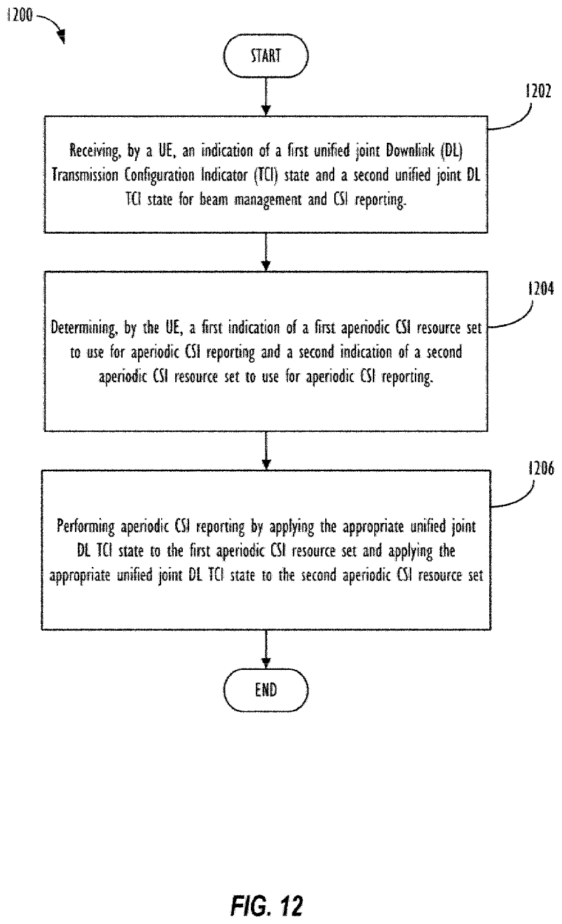

FIG. 12 is a flowchart for aperiodic CSI reporting, according to some aspects. In method 1200, the UE receives an indication of a first unified joint DL TCI state and a second unified joint DL TCI state for beam management and CSI reporting in block 1202. In such embodiments, if the UE is configured with group-based beam reporting, the number of aperiodic CSI Resource Sets configured may be set to 2.

In block 1204, the UE determines indications of a first and second aperiodic CSI resource sets for aperiodic CSI reporting. In some embodiments, a 1-bit indictor field may be added for each CSI-RS resource set to indicate ‘the first’ or ‘the second’ of the two indicated joint/DL TCI states for aperiodic CSI-RS reception. For example, one indictor value for a CSI Resource Set is set to be ‘0’ (i.e., first TCI State) and the second indicator value for the other CSI Resource Set shall be set to be ‘1’ (i.e., the second TCI state).

In some embodiments, for sDCI-based mTRP, the first TCI State may be implicitly applied for the CSI Resource Set with lower ID and the second TCI State is applied for the CSI Resource Set with a larger ID.

In some embodiments, for mDCI-based mTRP, the joint/DL TCI State associated with coresetPoolIndex=0 may be implicitly applied for the CSI Resource Set with lower ID, and the joint/DL TCI State associated with coresetPoolIndex=1 may be implicitly applied for the CSI Resource Set with a larger ID.

In accordance with embodiments disclosed herein, implicitly applying the CSI resource with the lower ID may be defined as a default mapping rule. In some embodiments, the default mapping rule may only be applied if 1-bit indictor IEs are not provided for the two CSI Resource Sets associated with a group-based beam reporting.

In block 1206, the aperiodic CSI reporting is performed by applying the appropriate unified joint DL TCI state to the first aperiodic CSI resource set and applying the appropriate unified joint DL TCI state indicated to the second aperiodic CSI resource set.

Embodiments disclosed herein provide an improved TCI state BM for mTRP communication in a light-weight TCI framework. Embodiments have the advantage of using implicit BFD-RS mappings for BFD, BFR, CJT-PDSCH reception, and aperiodic CSI reporting that may reduce signaling overhead.

Aspects of the present disclosure may be realized in any of various forms. For example, some aspects may be realized as a computer-implemented method, a computer-readable memory medium, or a computer system. Other aspects may be realized using one or more custom-designed hardware devices such as ASICs. Still other aspects may be realized using one or more programmable hardware elements such as FPGAs.

In some aspects, a non-transitory computer-readable memory medium may be configured so that it stores program instructions and/or data, where the program instructions, if executed by a computer system, cause the computer system to perform a method (e.g., any of a method aspects described herein, or, any combination of the method aspects described herein, or any subset of any of the method aspects described herein, or any combination of such subsets).

In some aspects, a device (e.g., a UE 106, a BS 102) may be configured to include a processor (or a set of processors) and a memory medium, where the memory medium stores program instructions, where the processor is configured to read and execute the program instructions from the memory medium, where the program instructions are executable to implement any of the various method aspects described herein (or, any combination of the method aspects described herein, or, any subset of any of the method aspects described herein, or, any combination of such subsets). The device may be realized in any of various forms.

Although the aspects above have been described in considerable detail, numerous variations and modifications will become apparent to those skilled in the art once the above disclosure is fully appreciated. It is intended that the following claims be interpreted to embrace all such variations and modifications.

What is claimed is:

1. (canceled)

2. (canceled)

3. A method of Beam Failure Detection (BFD), the method comprising:
receiving, by a receiver of a User Equipment (UE), a Medium Access Control-Control Element (MAC-CE) comprising a plurality of active Transmission Configuration Indicator (TCI) states;
wherein a pair of active TCI states of the plurality of active TCI states consists of a first TCI state and a second TCI state, wherein the first TCI state is associated with a first Transmission Reception Point (TRP), and the second TCI state is associated with a second TRP;
transmitting, by a transmitter of the UE, a number of BFD-RS resources per set capability of the UE to the network in a UE capability message;
determining, by a processor of the UE, that single Downlink Control Information (sDCI) multiple-TRP (mTRP) communication is enabled;
determining, by a processor of the UE, that no BFD-RS resource set was explicitly configured in any previous Radio Resource Control (RRC) signal received by the UE;
deriving a first BFD-RS resource set by including the RS sets of the first TCI state of an active TCI state pair of the plurality of active TCI states;
deriving a second BFD-RS resource set by including the RS sets of the second TCI state of the active TCI state pair of the plurality of active TCI states;
repeatedly associating additional BFD-RS resources by including the RS sets of a first TCI state and a second TCI state of the remaining active TCI state pairs to the first BFD-RS resources set and the second BFD-RS resource sets, respectively, until the number of BFR-RS resources per set is equal to the capability that is reported by the UE.

4. The method of claim 3, wherein associating additional BFD-RS resources using RSs of the plurality of active TCI state pairs is based on a periodicity of the search space set and a value of a Control Resource Set (CORESET) index that is associated with the active TCI-states in the active TCI state pair.

5. The method of claim 4, wherein additional BFD-RS resource of TCI-state associated with a search space set or a CORESET is selected if the periodicity of the search space set is less than or equal to the periodicity of the other search space sets, and the value of the CORESET index is smaller than or equal to the CORESET index of the TCI state.

6. The method of claim 3, wherein the MAC-CE is received in a PDSCH that is scheduled by a DCI detected in a Control Resource Set (CORESET).

7. A method of Beam Failure Recovery (BFR) comprising:
detecting, by a processor of a User Equipment (UE), a beam failure based on a measurement obtained from a Beam Failure Detection (BFD)-Reference Signal (RS) resource;
determining, by the processor, a BFD-RS set identification (ID) associated with the failed BFD-RS resource and a Candidate Beam Detection (CBD)-RS ID, wherein the BFD-RS set and CBD-RS set are associated with the same Transmission Reception Point (TRP) with a same TCI-state;
transmitting, by a transmitter of the UE, a Medium Access Control-Control Element (MAC-CE) comprising the BFD-RS set ID and the CBD-RS ID to the network;
upon receiving a response to the transmission of the MAC-CE, determining an uplink spatial filter based on the CBD-RS associated with the CBD-RS ID; and
transmitting the uplink channels using the uplink spatial filter.

8. The method of claim 7, wherein the CBD-RS set information is configured for the UE via Radio Resource Control (RRC) signaling.

9. A method of decoding a Coherent Joint Transmission (CJT)-Physical Downlink Shared Channel (PDSCH), the CJT-PDSCH being joint precoded and transmitted across a plurality of Transmission Reception Points (TRPs), the method comprising:
receiving, an indication of a first and second unified joint Downlink (DL) Transmission Configuration Indicator (TCI) state from a network;
wherein a first CJT-PDSCH Demodulation Reference Signal (DMRS) port is quasi-co-located with a DL Reference Signal (RS) of the first unified joint DL TCI state by quasi co-location (QCL) Type A;
determining a QCL Type of a second CJT-PDSCH DMRS port with respect to a second DL RS of the second unified joint DL TCI state; and
decoding the CJT-PDSCH using the first and second CJT-PDSCH DMRS ports.

10. The method of claim 89, wherein the QCL type of the second CJT-PDSCH DMRS port with respect to the second DL RS of the second unified joint DL TCI state is Type E that indicates a quasi co-location relationship between the second DL RS and the CJT-PDSCH DMRS port as {average delay, delay spread}.

11. The method of claim 89, wherein the QCL type of the second CJT-PDSCH DMRS port with respect to the second DL RS of the second unified joint DL TCI state is Type B that indicates a quasi co-location relationship between the second DL RS and the CJT-PDSCH DMRS port as {Doppler shift, Doppler spread}.

12. The method of claim 89, wherein the QCL type of the second CJT-PDSCH DMRS port with respect to the second DL RS of the second unified joint DL TCI state is Type A that indicates a quasi co-location relationship between the second DL RS and the CJT-PDSCH DMRS port as {Doppler shift, Doppler spread, average delay, delay spread}.

13. The method of claim 89, wherein the QCL type of the second CJT-PDSCH DMRS port with respect to the second DL RS of the second unified joint DL TCI state is signaled through RRC signaling.

14. (canceled)

15. (canceled)

16. (canceled)

17. (canceled)

18. (canceled)

19. (canceled)

20. (canceled)

21. (canceled)

22. (canceled)

23. (canceled)
